(19) United States
(12) Patent Application Publication
(10) Pub. No.: US 2013/0024771 A1
(43) Pub. Date: Jan. 24, 2013

(54) Systems and Methods for Providing and Managing Virtual Music Cards with Music Streaming Capability

(71) Applicant: Jonathon Osland Satterley, New York, NY (US)

(72) Inventor: Jonathon Osland Satterley, New York, NY (US)

(73) Assignee: THE ALL BLACKS B.V., GD Naarden (NL)

(21) Appl. No.: 13/185,706

(22) Filed: Jul. 19, 2011

(51) Int. Cl. G06F 3/01; G06F 15/16

(52) U.S. Cl. 715/716; 715/748

(57) ABSTRACT

Access to a virtual music card associated with a song and having a plurality of virtual sides, wherein at least one virtual side comprises an option for streaming the song, is provided to a user device. A selection of the option to stream the song is received from the user device, and an audio file of the song is streamed to the user device, in response to the selection of the option. The virtual music card may comprise a first virtual side showing an image of an artist associated with the song, and a second virtual side comprising an option to stream the song. The virtual music card may also comprise a third side showing an attribute associated with the artist, and a fourth side showing a graphic design.

### FIELD OF THE INVENTION

This invention relates generally to systems and methods for providing and managing virtual music cards, and more particularly to systems and methods for providing and managing virtual music cards having a music streaming capability.

### BACKGROUND

Current methods and systems for distributing music include the sale of physical CDs in stores and the distribution of audio files, such as mp3 files, via the Internet. A purchaser typically visits a physical store to purchase a CD or visits a World Wide Web site to purchase an audio file of a song. Recently, some Web sites have allowed purchasers to acquire the right to have a particular song streamed to the user's device, usually for a specified period of time.

### SUMMARY OF THE INVENTION

In an embodiment of the invention, a method for providing music via a virtual music card is provided. Access to a virtual music card associated with a song and having a plurality of virtual sides, wherein at least one virtual side comprises an option for streaming the song, is provided to a user device. A selection of the option to stream the song is received from the user device, and an audio file of the song is streamed to the user device, in response to the selection of the option. The virtual music card may comprise a first virtual side showing an image of an artist associated with the song, and a second virtual side comprising an option to stream the song. The virtual music card may also comprise a third side showing an attribute associated with the artist, and a fourth side showing a graphic design.

In one embodiment, the audio file of the song is stored in a memory. The user device displays the virtual side that includes the option for streaming the song. When the option to stream the song is selected by a user, the audio file is accessed and streamed to the user device. In another embodiment, a selection of a second option to pause the music stream is received from the user device, and the music stream is paused, in response to the selection of the second option.

Information relating to the virtual music card may be stored in a user account. In one embodiment, the user device displays a web page showing the virtual music card and one or more second virtual music cards associated with the user account. When a selection of the virtual music card is received from the user device, at least one virtual side of the virtual music card is displayed, in response to the selection of the virtual music card.

In another embodiment, information relating to a transfer of a virtual music card to the user from a second user is received. In response, a first user account of the user and a second user account of the second user are updated to indicate the transfer of the virtual music card.

In another embodiment, a code associated with a physical card purchased from a merchant is received from a user device, and a virtual music card is generated based on the code.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to distribute and manage virtual music cards, in accordance with an embodiment of the invention;

FIGS. 2A-2D illustrate four virtual sides of a virtual music card, in accordance with an embodiment of the invention;

FIG. 3 shows components of a virtual music card manager, in accordance with the embodiment of FIG. 1;

FIG. 4 shows a virtual music card user account Web page, in accordance with an embodiment of the invention;

FIG. 5 is a flowchart of a method for streaming a song associated with a virtual music card to a user device, in accordance with an embodiment of the invention; and

FIG. 6 is a high-level block diagram of a computer, in accordance with an embodiment of the invention.

### DETAILED DESCRIPTION

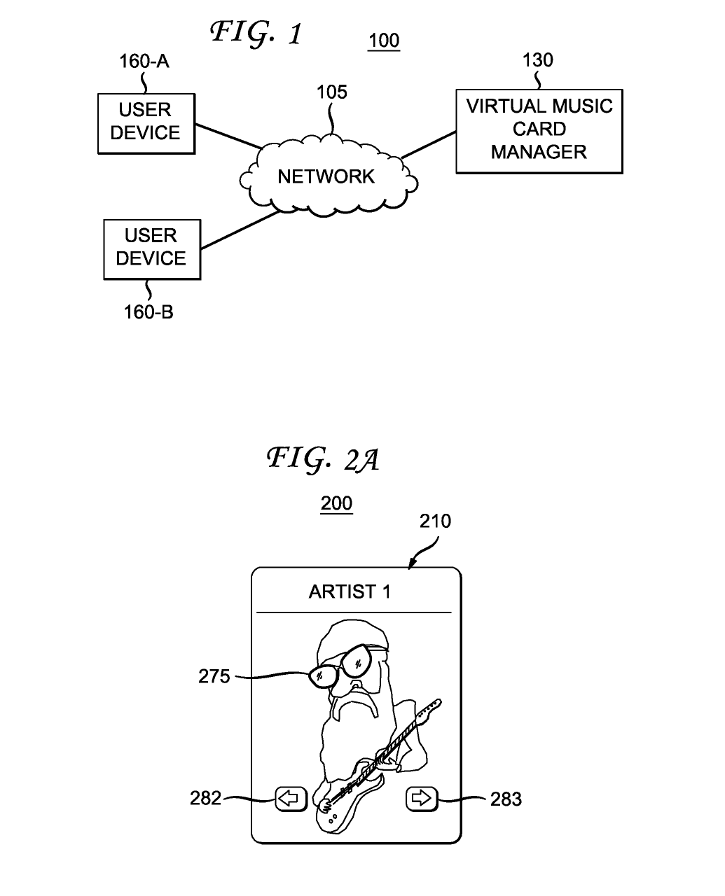

FIG. 1 shows a communication system 100 that may be used to distribute and manage virtual music cards, in accordance with an embodiment of the invention. Communication system 100 comprises a network 105, a virtual music card manager 130, and user devices 160-A, 160-B, etc. For convenience, the term “user device 160” is used herein to refer to any one of user devices 160-A, 160-B, etc. Accordingly, any discussion herein referring to “user device 160” is equally applicable to each of user devices 160-A, 160-B, etc. Communication system 100 may comprise more or fewer than two user devices.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

User device 160 may be any device that enables a user to communicate via network 105. User device 160 may be connected to network 105 through a direct (wired) link, or wirelessly. User device 160 may have a display screen (not shown) for displaying information. User device may also include one or more audio speakers (not shown) for generating music and other audio signals. User device 160 may comprise a buffer, a decoder, and other components for receiving, decoding, and playing back streamed audio data. For example, user device 160 may be a personal computer, a laptop computer, a workstation, a mainframe computer, etc. Alternatively, user device 160 may be a mobile communication device such as a cell phone, a Blackberry, a personal digital assistant, etc. Other devices may be used.

In accordance with the embodiment of FIG. 1, a user may interact with virtual music card manager 130 in order to purchase, sell, or trade virtual music cards, maintain a collection of virtual music cards, and/or play virtual music card games.

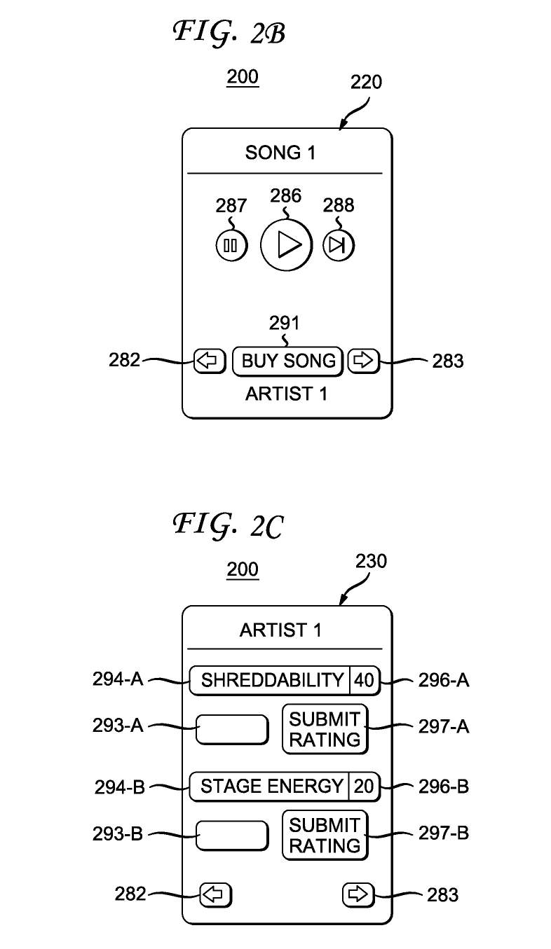

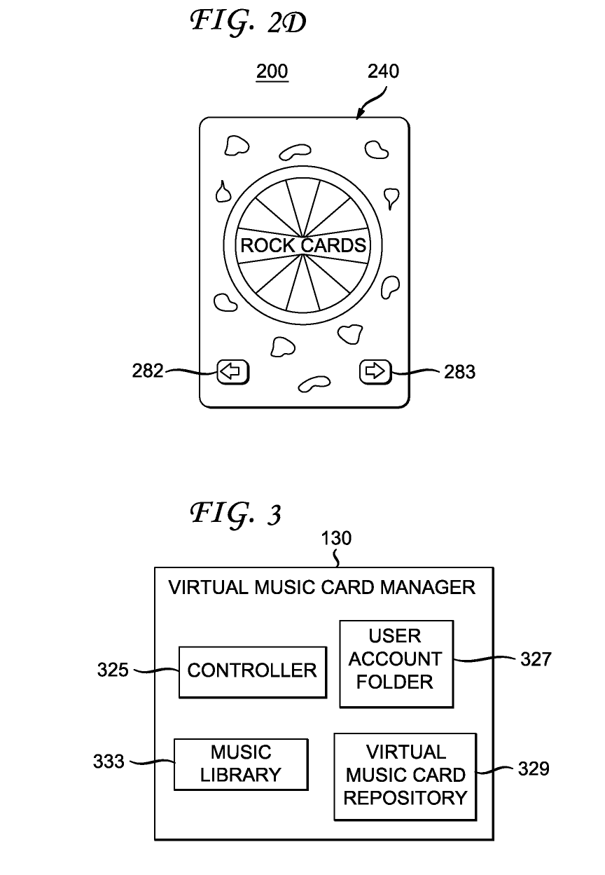

FIGS. 2A-2D show four virtual sides of a virtual music card 200, in accordance with an embodiment of the invention. Virtual music card 200 is associated with a particular song, SONG1, performed by a particular artist, ARTIST1.

In an embodiment of the invention, a virtual side of a virtual music card comprises a defined set of information relating to an artist and/or song, which may be displayed on user device 160. A virtual side may also comprise an option to perform an action, such as an option to turn to (e.g., display) another virtual side, or an option to stream a song to a user device.

FIG. 2A illustrates a front side 210 of virtual music card 200. Front side 210 comprises an image 275 of the artist, ARTIST1. Front side 210 also includes a previous side button 282 which provides to a user an option to turn to the “previous side” of virtual music card 200, and a next side button 283 which provides an option to turn to the “next side.”

FIG. 2B shows a second side 220 of virtual music card 200. Second side 220 displays the song name, SONG1, and includes a play button 286 which provides an option to play the song. Second side 220 also comprises a buy song button 291, which provides an option to purchase an audio file of the song. When a user selects play button 286, an audio file of the song is streamed to user device 160. When a user selects buy song button 291, an audio file of the song is downloaded to user device 160. Second side 220 also includes a pause button 287 and a fast forward button 288, allowing a user to manipulate music as it streamed to user device 160. Other control buttons allowing a user to control other aspects of the streaming of an audio file may be included.

FIG. 2C shows a third side 230 of virtual music card 200, in accordance with an embodiment of the invention. Third side 230 comprises one or more attributes 294 associated with the artist, ARTIST1. Attributes 294 may relate to the artist's skills, aspects of the artist's performance, the artist's appearance, etc. In this example, attributes 294 include attribute 294-A (SHREDDABILITY) and attribute 294-B (STAGE ENERGY). For each attribute 294, a user rating 296 is specified. In this example, each user rating, including user ratings 296-A and 296-B, is a value between one and one hundred.

FIG. 2D shows a back side 240 of virtual music card 200, in accordance with an embodiment of the invention. Back side 240 includes a decorative graphic design, which may be associated with the virtual music card service provider, or associated with ARTIST1.

In other embodiments, additional information associated with an artist or song may be indicated on one or more sides of virtual music card 200. For example, information concerning tour dates, artist biographical information, etc., may be included.

FIG. 3 shows functional components of virtual music card manager 130, in accordance with an embodiment of the invention. Virtual music card manager 130 comprises a controller 325, a user account folder 327, a virtual music card repository 329, and a music library 333. Virtual music card manager 130 may include other components not shown in FIG. 3.

In one embodiment, virtual music card manager 130 maintains various virtual music cards in virtual music card repository 329. For example, each virtual music card stored in repository 329 may comprise information identifying an artist and a song, and a location of an audio file of the song stored in music library 333. Each virtual music card may also comprise a unique identifier, such as a code. A virtual music card may comprise other types of information.

User account folder 327 stores information concerning various users' accounts. For example, user account folder 327 may include users' names, passwords, billing information, information specifying which virtual music cards are owned by various users, etc. For example, a user account of a particular user may comprise one or more codes identifying the virtual music cards that are owned by the user. A user account may also include information that may be used to personalize a virtual card owned by a particular user.

Music library 333 comprises audio files of songs associated with various virtual music cards. The audio files in music library 333 may be stored in a storage device, such as a disk drive, optical disk, tape drive, etc. Audio files may be stored in the form of mp3 audio files, for example. Songs may be stored using other formats and other types of storage devices.

In one embodiment, virtual music card manager 130 maintains a World Wide Web site that enables users to access their respective user accounts and to conduct various activities relating to virtual music cards. In other embodiments, virtual music card manager 130 may enable a user to access a user account and/or the user's virtual music cards via other platforms, such as via a cell phone, a gaming console, or via other internet touch points, including, without limitation, social networking websites.

In the embodiment of FIG. 1, virtual music card manager 130 may allow users to purchase virtual music cards online. For example, a user may access a shopping page (not shown) via a World Wide Web page maintained by virtual music card manager 130, browse one or more available virtual music cards, and select an option to “Buy Virtual Music Card,” to purchase a desired virtual music card. In response to the user's selection, controller 325 may update the user's account to reflect the purchase. Controller 325 may charge a user's account for various charges relating to purchases of virtual music cards and other activities relating to virtual music cards. Techniques for conducting purchases online are known.

In accordance with an embodiment of the invention, a user may log into his or her user account and view virtual music cards associated with the account. Suppose, for example, that a user employs an internet browser application operating on user device 160 to access a World Wide Web site maintained by virtual music card manager 130. In a well-known manner, the user may be required to authenticate his or her identity, e.g., by entering a user name and password, before accessing his or her user account. After the user is authenticated, controller 325 may cause user device 160 to display a user account Web page containing information indicating which virtual music cards are associated with the user's account. In other embodiments, a user may access his or her user account via other devices or platforms, such as via a cell phone, a gaming console, or via other internet touch points, such as via a social networking website.

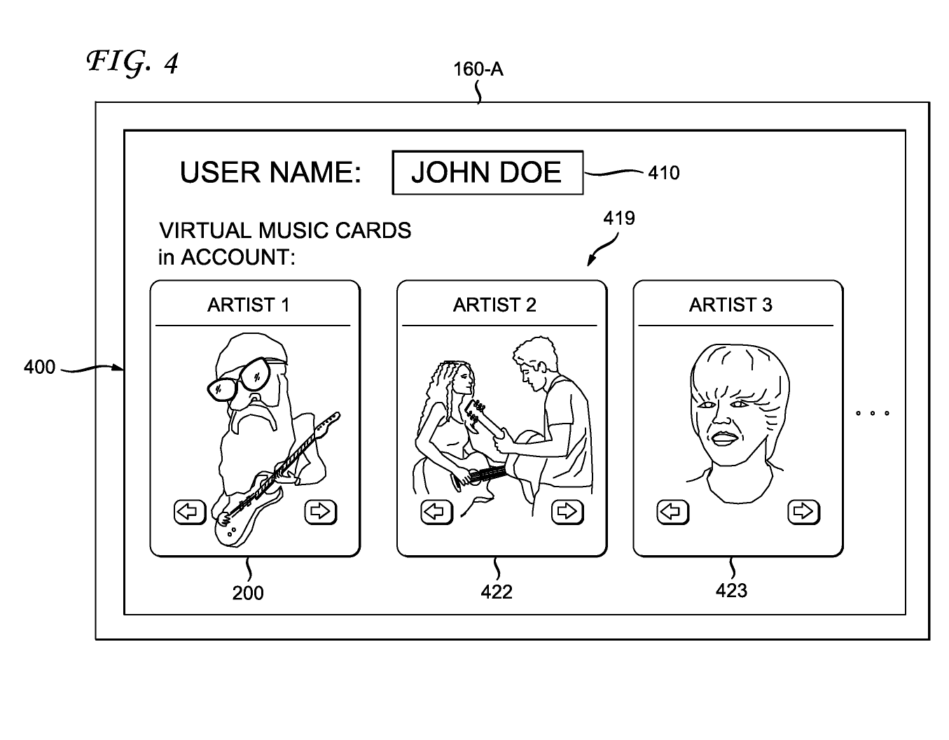

FIG. 4 shows a virtual music card user account Web page 400 that may be displayed on user device 160 after the user has logged into his or her user account, in accordance with an embodiment of the invention. User account web page 400 includes a user name field 410, displaying the user's name, and displays thumbnail images 419 of the virtual music cards which are associated with the user's account. In this example, the user's virtual music cards include virtual music card 200 as well as virtual music cards 422 and 423. A user may have any number of virtual music cards associated with his or her account. The user may access a desired card by selecting (e.g., clicking on) the displayed thumbnail image of the card.

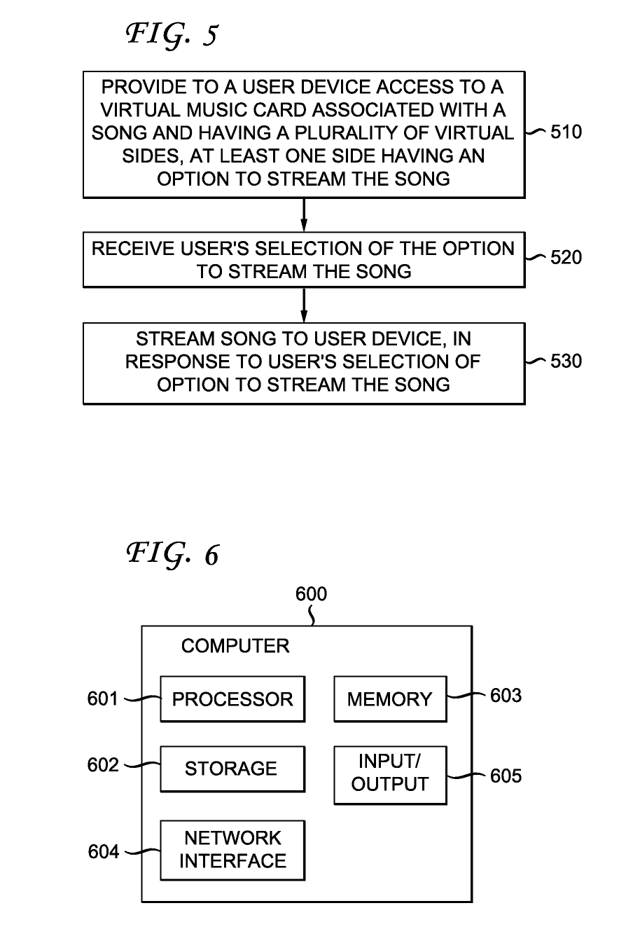

In accordance with an embodiment of the invention, a user may employ a virtual music card to cause a song to be streamed to a user device. FIG. 5 is a flowchart of a method for streaming a song associated with a virtual music card to a user device, in accordance with an embodiment of the invention. At step 510, access to a virtual music card associated with a song and having a plurality of virtual sides, wherein at least one of the virtual sides comprises an option for streaming the song, is provided to a user device. Referring again to FIG. 4, the user, wishing to listen to SONG1, may click on the thumbnail image of virtual music card 200 to gain access to virtual music card 200. When the user clicks on the thumbnail image of card 200, one or more virtual sides of virtual music card 200 are displayed on user device 160.

In one embodiment, when the user clicks on the thumbnail image of card 200, controller 325 causes user device 160 to display first side 210 (FIG. 2A). For example, controller 325 may transmit to user device 160 selected information relating to virtual music card 200 and instruct user device 160 to display the information associated with first page 210. The user, wishing to listen to SONG1, selects next side button 283 to turn to second side 220 (FIG. 2B). In response, controller 325 causes user device 160 to display second side 220. The user now selects play button 286, causing user device 160 to transmit to virtual music card manager 130 a signal indicating that the user has selected the option to stream SONG1.

Referring again to FIG. 5, the user's selection of the option to stream SONG1 is received from user device 160, at step 520. In the present example, controller 325 receives the signal indicating that the user has selected the option to stream SONG1.

At step 530, the song is streamed to user device 160, in response to the user's selection of the streaming option. In the present example, controller 325 accesses music library 333, retrieves the audio file of SONG1, and streams SONG1 via network 105 to user device 160. Methods and systems for streaming audio data are known.

User device 160 receives the streamed audio data via network 105 and plays back SONG1. The user may listen to SONG1 through audio speakers on user device 160-A, for example.

The user may further manipulate the streaming of the audio file by selecting pause and fast-forward options. For example, suppose that while the audio file of SONG1 is being streamed to user device 160, the user selects pause button 287 (shown in FIG. 2B). In response to the user's selection of the pause option, user device 160 transmits a pause signal to virtual music card manager 130. In response to the pause signal, controller 325 pauses the stream of the audio file of SONG1. Other control signals may be used in a similar manner.

In another embodiment of the invention, a user may employ a virtual music card to download an audio file of a song. Referring to FIG. 2B, second side 220 comprises buy song button 291, which represents an option to download the audio file of SONG1. When the user selects the download option, by pressing buy song button 291, controller 325 retrieves the audio file of SONG1 from music library 333 and transmits the audio file to user device 160. Controller 325 may also store the audio file of the selected song in the user's account, or elsewhere, in association with the virtual music card, to enable the user to access the audio file at a later time.

In another embodiment, each artist attribute 294 (shown in FIG. 2C) is determined based on ratings received from users. In the example of FIG. 2C, second side 220 includes one or more rating entry fields 293 and corresponding submit rating buttons 297. For example, a user may submit a rating for attribute 294-A (SHREDDABILITY), by entering in field 293-A a value between one and one hundred and pressing submit rating button 297-A. In one embodiment, all ratings submitted by users for a respective attribute of a particular artist are averaged to determine the overall user rating for that attribute. User ratings for attributes may be determined using other methods.

In another embodiment of the invention, a user may purchase a physical music card, obtain a code from the physical music card, and obtain a virtual music card based on the code. For example, a user may purchase a physical music card from a merchant, such as a store which sells music-related items such as CDs. In one embodiment, physical music cards may be sold individually or in decks, which may include any number of cards.

In one example, a physical music card includes a first side having an image of an artist and a second side indicating a particular song performed by the artist. One side of the physical card also includes a scratch-off region containing a code which is revealed by scratching the region, in a well-known manner. The user may subsequently log into his or her user account via user device 160, and use the code to obtain a virtual music card. For example, virtual music card manager 130 may present a Web page (not shown) allowing the user to enter the code obtained from the physical card. Upon receiving the code, controller 325 generates a virtual music card that corresponds to the physical card, and updates the user's account to reflect the addition of the virtual music card.

In an embodiment of the invention, virtual music card manager 130 may manage one or more marketplaces in which virtual music cards may be transferred from a first user to a second user. For example, virtual music card manager 130 may maintain an online card trading marketplace allowing users to interact and trade virtual music cards. In another embodiment, virtual music card manager 130 conducts an online card auction market allowing users to sell virtual music cards at auction. Management of online trading marketplaces and online auction markets are known.

In another embodiment, virtual music card manager 130 manages one or more online games allowing users to play various card games. Rights to participate in one or more games may be attached to a virtual music card. Some games may include rules requiring a user who loses a game to forfeit one or more virtual music cards to the winner.

In various embodiments, one or more specified rights may be attached to a virtual music card. For example, a right to stream and/or purchase music associated with a virtual music card may be attached to the card. A right to participate in one or more online games may be attached to a virtual music card. Other rights may be attached to a virtual music card.

In certain embodiments, all of the rights attached to a card are transferrable. In other embodiments, none of the rights attached to a card are transferrable. In other embodiments, only some of the rights attached to a card are transferrable. Thus, in certain embodiments, when a virtual music card is transferred from a first user to a second user, the second user obtains only a limited subset of rights associated with the virtual music card that does not include all of the rights previously possessed by the first user.

In one embodiment, a right to stream (and/or download) a particular song associated with a virtual music card is attached to the virtual music card and is transferrable. Accordingly, when a virtual music card associated with a particular song is transferred from a first user to a second user, the right to stream (and/or download) the song may be transferred with the virtual music card to the second user. For example, when controller 325 receives information indicating that a virtual music card is to be transferred from a first user to a second user, controller 325 updates the respective user accounts of the first user and the second user to reflect the transfer.

In an alternative embodiment, a right to stream and/or purchase a song associated with a virtual music card is not transferrable. Accordingly, a first user may, upon purchasing a virtual music card that is associated with a particular song, obtain rights to play specified online games and rights to stream and purchase the song. However, when the first user sells or otherwise transfers the virtual music card to a second user, the second user obtains only the rights to play the specified online games but not the rights to stream and purchase the song. The second user may be required to pay a fee to obtain rights to stream and/or purchase the song associated with the virtual music card. Such a fee may be a one-time payment or part of a recurring subscription fee, for example. Therefore, when controller 325 receives information indicating that a virtual music card is to be transferred from a first user to a second user, controller 325 updates the respective user accounts of the first user and the second user to reflect the transfer and to reflect the first user's and second user's updated rights information. For example, the second user's account may be updated to indicate that the second user owns the virtual music card and possesses rights to play one or more games, but does not have a right to stream the song associated with the virtual music card.

The above-described systems and methods can be implemented on one or more computers using well-known computer processors, memory units, storage devices, computer software, and other components. A high-level block diagram of such a computer is illustrated in FIG. 6. Computer 600 contains a processor 601, which controls the overall operation of computer 600 by executing computer program instructions that define such operations. The computer program instructions may be stored in a storage device 602, or other computer readable medium (e.g., magnetic disk, CD ROM, etc.), and loaded into memory 603 when execution of the computer program instructions is desired. Thus, the method steps of FIG. 5 can be defined by the computer program instructions stored in the memory 603 and/or storage 602 and controlled by the processor 601 executing the computer program instructions. For example, the computer program instructions can be implemented as computer executable code programmed by one skilled in the art to perform an algorithm defined by the method steps of FIG. 5. Accordingly, by executing the computer program instructions, the processor 601 executes an algorithm defined by the method steps of FIG. 5. Computer 600 also includes one or more network interfaces 604 for communicating with other devices via a network. Computer 600 also includes one or more input/output devices 605 that enable user interaction with computer 600 (e.g., display, keyboard, mouse, speakers, buttons, etc.). One skilled in the art will recognize that an implementation of an actual computer could contain other components as well, and that FIG. 6 is a high level representation of some of the components of such a computer for illustrative purposes. Computer 600 may also include peripherals, such as a printer, scanner, display screen, etc.

Any or all of the systems, processors, and apparatus discussed herein, including virtual music card manager 130, user device 160, and controller 325, may be implemented using a computer such as computer 600. In addition, components described herein, including user account folder 327, music library 333, and virtual music card repository 329, may be maintained by a computer, such as computer 600, in a memory or storage, such as memory 603 or storage 602.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for providing music via a virtual music card, the method comprising:
providing to a user device access to a virtual music card, the virtual music card being associated with a song and having a plurality of virtual sides, wherein at least one virtual side comprises an option for streaming the song;
receiving from the user device a selection of the option to stream the song; and
streaming an audio file of the song to the user device, in response to the selection of the option.

2. The method of claim 1, wherein the virtual music card comprises:
a first virtual side showing an image of an artist associated with the song; and
a second virtual side comprising an option to stream the song.

3. The method of claim 2, wherein the virtual music card comprises a third side showing an attribute associated with the artist.

4. The method of claim 3, wherein the virtual music card comprises a fourth side showing a graphic design.

5. The method of claim 1, wherein the audio file of the song is stored in a memory, the method further comprising:
accessing the stored audio file of the song, in response to the selection of the option to stream the song.

6. The method of claim 5, further comprising:
causing the user device to display the virtual side that comprises the option for streaming the song.

7. The method of claim 1, further comprising:
receiving from the user device a selection of a second option to pause the music stream; and
pausing the streaming of the audio file, in response to the selection of the second option.

8. The method of claim 1, wherein information relating to the virtual music card is stored in a user account, the step of providing to a user device access to a virtual music card further comprising:
causing the user device to display a web page showing the virtual music card and one or more second virtual music cards associated with the user account;
receiving from the user device a selection of the virtual music card; and
causing the user device to display at least one virtual side of the virtual music card, in response to the selection of the virtual music card.

9. The method of claim 1, further comprising:
receiving information relating to a transfer of a virtual music card to the user from a second user; and
updating a first user account of the user and a second user account of the second user to indicate the transfer of the virtual music card.

10. The method of claim 9, further comprising:
updating the second user account of the second user to indicate that the second user owns the virtual music card but does not have a right to stream the song.

11. The method of claim 1, further comprising:
receiving from the user device a code associated with a physical card purchased from a merchant; and
generating the virtual music card based on the code.

12. An apparatus for providing music via a virtual music card, the apparatus comprising:
means for providing to a user device access to a virtual music card, the virtual music card being associated with a song and having a plurality of virtual sides, wherein at least one virtual side comprises an option for streaming the song;
means for receiving from the user device a selection of the option to stream the song; and
means for streaming an audio file of the song to the user device, in response to the selection of the option.

13. The apparatus of claim 12, wherein the virtual music card comprises:
a first virtual side showing an image of an artist associated with the song; and
a second virtual side comprising an option to stream the song.

14. The apparatus of claim 12, wherein the audio file of the song is stored in a memory, the apparatus further comprising:
means for accessing the stored audio file of the song, in response to the selection of the option to stream the song.

15. The apparatus of claim 12, further comprising:
means for causing the user device to display the virtual side that comprises the option for streaming the song.

16. The apparatus of claim 12, wherein information relating to the virtual music card is stored in a user account, the apparatus further comprising:
means for causing the user device to display a web page showing the virtual music card and one or more second virtual music cards associated with the user account;
means for receiving from the user device a selection of the virtual music card; and
means for causing the user device to display at least one virtual side of the virtual music card, in response to the selection of the virtual music card.

17. A non-transitory computer readable medium having program instructions stored thereon, the instructions capable of execution by a processor and defining the steps of:
providing to a user device access to a virtual music card, the virtual music card being associated with a song and having a plurality of virtual sides, wherein at least one virtual side comprises an option for streaming the song;
receiving from the user device a selection of the option to stream the song; and
streaming an audio file of the song to the user device, in response to the selection of the option.

18. The non-transitory computer readable medium of claim 17, wherein the virtual music card comprises:
a first virtual side showing an image of an artist associated with the song; and
a second virtual side comprising an option to stream the song.

19. The non-transitory computer readable medium of claim 17, wherein the audio file of the song is stored in a memory, the non-transitory computer readable medium further comprising instructions that define the step of:
accessing the stored audio file of the song, in response to the selection of the option to stream the song.

20. The non-transitory computer readable medium of claim 17, further comprising instructions that define the step of:
causing the user device to display the virtual side that comprises the option for streaming the song.

21. The non-transitory computer readable medium of claim 17, wherein information relating to the virtual music card is stored in a user account, the instructions defining the step of providing to a user device access to a virtual music card further comprise instructions defining the steps of:
causing the user device to display a web page showing the virtual music card and one or more second virtual music cards associated with the user account;
receiving from the user device a selection of the virtual music card; and
causing the user device to display at least one virtual side of the virtual music card, in response to the selection of the virtual music card.
